(19) United States
(12) Patent Application Publication
(10) Pub. No.: US 2005/0259580 A1
(43) Pub. Date: Nov. 24, 2005

(54) Fixed network utility data collection system and method

(76) Inventors: Christopher Osterloh, Waseca, MN (US); Neil Hovelsrud, Waseca, MN (US); Gary L. Larson, Waseca, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/114,900

(22) Filed: Apr. 26, 2005

Related U.S. Application Data
(60) Provisional application No. 60/565,401, filed on Apr. 26, 2004.

(51) Int. Cl. H04L 1/00

(52) U.S. Cl. 370/231

(57) ABSTRACT

A fixed network utility data collection system includes a plurality of endpoints arranged in a tiered and spoke-like configuration relative to a central data collecting device. An RF transmission from the central device transmits out over the endpoints in a spoke. The first endpoint in the spoke to hear the transmission then hops the transmission to the other endpoints in the spoke. Once all of the endpoints in a spoke have received the transmission they respond to the transmission. The response starts with the outer-most endpoint and is transmitted to the next endpoint in the spoke line. That endpoint adds its response and forwards the message to the next endpoint in the spoke line and so on. Upon the inner-most endpoint of the spoke receiving the response, it adds its response and transmits the final collective response to the central device.

### CLAIM TO PRIORITY

The present application claims priority to U.S. Provisional Patent Application No. 60/565,401, filed Apr. 26, 2004, and entitled “FIXED NETWORK UTILITY DATA COLLECTION SYSTEM AND METHOD.” The contents of the cited provisional patent application is hereby incorporated by reference.

### FIELD OF THE INVENTION

The present invention relates generally to radio frequency (RF) communication systems, and more particularly to RF communication schemes used with advanced automatic meter reading (AMR) devices.

### BACKGROUND OF THE INVENTION

Automatic meter reading (AMR) systems are generally known in the art. Utility companies, for example, use AMR systems to read and monitor customer meters remotely, typically using radio frequency (RF) and other wireless communications. AMR systems are favored by utility companies and others who use them because they increase the efficiency and accuracy of collecting readings and managing customer billing. For example, utilizing an AMR system for the monthly reading of residential gas, electric, or water meters eliminates the need for a utility employee to physically enter each residence or business where a meter is located to transcribe a meter reading by hand.

There are two general ways in which current AMR systems are configured, fixed networks and mobile networks. In a fixed network, endpoint devices at meter locations communicate with readers that collect readings and data using RF communication. There may be multiple fixed intermediate readers, or relays, located throughout a larger geographic area on utility poles, for example, with each endpoint device associated with a particular reader and each reader in turn communicating with a central system. Other fixed systems utilize only one central reader with which all endpoint devices communicate. In a mobile network, a handheld unit or otherwise mobile reader with RF communication capabilities is used to collect data from endpoint devices as the mobile reader moves from place to place. The differences in how data is reported up through the system and the impact that has on number of units, data transmission collisions, frequency and bandwidth utilization has resulted in fixed network AMR systems having different communication architectures than mobile network AMR systems.

AMR systems can include one-way, one-and-a-half-way, or two-way communications capabilities. In a one-way system, an endpoint device typically uses a low power count down timer to periodically turn on, or “bubble up,” in order to send data to a receiver. One-and-a-half-way AMR systems include low power receivers in the endpoint devices that listen for a wake-up signal which then turns the endpoint device on for sending data to a receiver. Two-way systems enable two way command and control between the endpoint device and a receiver/transmitter. Because of the higher power requirements associated with two-way systems, two-way systems have not been favored for residential endpoint devices where the need for a long battery life is critical to the economics of periodically changing out batteries in these devices.

While conventional fixed networks provide many advantages over manually read meters, they suffer from at least two significant drawbacks. First, conventional fixed networks are generally handicapped by cell size. Because of timing, geographic, and power constraints, central data collection units are limited in the number of meters they may support. Introducing, dedicated intermediate relay units can rectify this problem to a certain degree, but these relay units suffer from similar drawbacks and increase system complexity and cost. Second, conventional fixed network systems are limited by the power consumption and battery life of the individual meters. Configuring the meters to respond to or initiate communications with a central device is a drain on the battery life of the meters. The meters still require frequent manual servicing to change out batteries, defeating the most significant advantage of a fixed network system.

There is, therefore, a need in the industry for an AMR system that addresses the data collection shortcomings of conventional fixed network systems while providing larger cell sizes and more efficient communication with meter devices.

### SUMMARY OF THE INVENTION

The invention substantially meets the aforementioned needs of the industry, in particular a system and method of operating AMR systems that allow for the storage and transfer of meter readings and other data to eliminate the need to physically visit a remote endpoint device and connect directly to the endpoint device for the collection of data.

In a preferred embodiment, the invention enables communication between a plurality of devices in a fixed network utility data collection system. In one embodiment, the system generally comprises a cell defining a geographical area and includes a central radio device and a plurality of radio-equipped endpoint devices. The central radio device communicates in a “spoke”-like manner with each of the plurality of endpoint devices in the cell. Additionally, the endpoint devices may communicate peer-to-peer within the cell.

The peer-to-peer communication capability of a preferred embodiment of the invention enlarges the communicative radius of the cells in which the system is implemented and reduces the overall cost of the system. Peer-to-peer communication between endpoint devices arranged in “spokes” enables a larger number of endpoint devices to be under the umbrella of a single central radio device. Further, peer-to-peer communications reduce the power consumption of the devices in the system by reducing the endpoint device wake-up times necessary to communicate with a single central radio device.

The above summary of the present invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is an exemplary diagram of a cell layout in accordance with one embodiment of the system of the invention.

FIG. 2 is a diagram of a single cell of FIG. 1 in accordance with one embodiment of the system of the invention.

FIG. 3 is a communication path diagram in accordance with one embodiment of the invention.

FIG. 4 is a timing diagram in accordance with one embodiment of the system of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

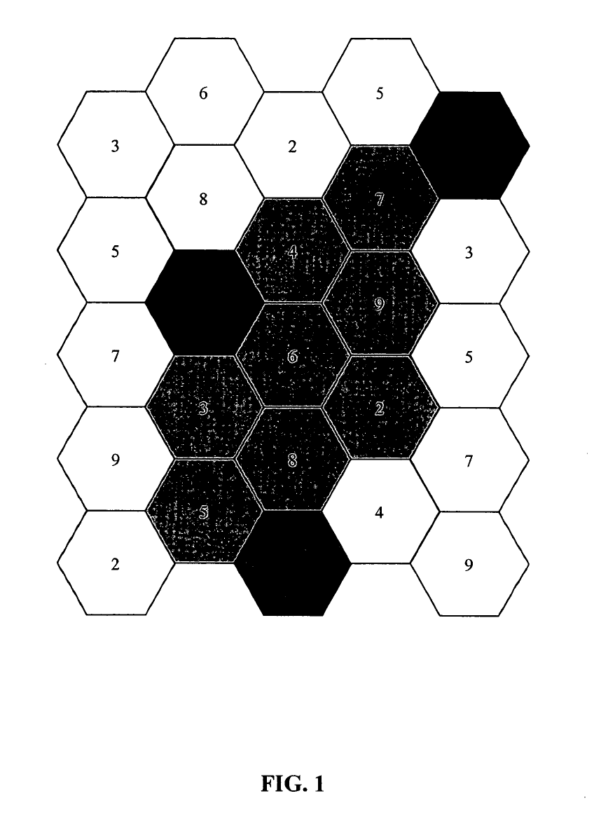

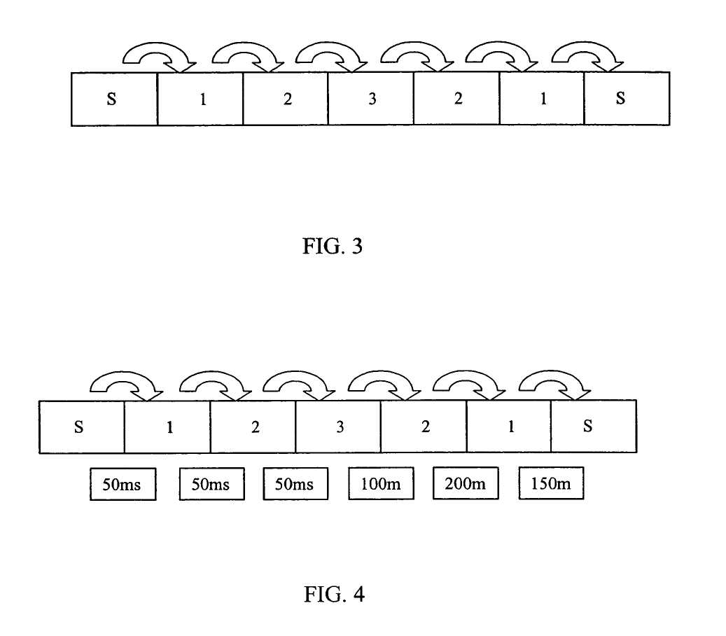

The fixed network utility data collection system and method of the invention provide increased communication capabilities in an enlarged geographical area while reducing device battery consumption. The invention can be more readily understood by reference to FIGS. 1-4 and the following description. While the invention is not necessarily limited to such an application, the invention will be better appreciated using a discussion of example embodiments in such a specific context.

An exemplary cell layout 10 is shown in FIG. 1. In this example embodiment, cell layout 10 corresponds to a geographic area and utilizes a nine cell reuse pattern. The channels for each individual cell have been chosen to avoid any cell having an adjacent cell with a co-channel or an adjacent channel within the overall cell layout 10. Each individual cell preferably comprises a central radio device and a plurality of endpoint devices, or meters. Here and throughout this application the term “endpoint device” will be used to generally refer to the meter and communications circuitry as one remote device even though they may in some embodiments be distinct devices, with a reader communicating with the communications circuitry and the communications circuitry in turn communicating with the actual meter using RF.

The frequency band that the system uses in the United States is 1427.000-1432.000 megaHertz (MHz) in one preferred embodiment. This frequency band is broken into five sub-bands, each having a bandwidth of 1.000 MHz; these sub-bands are as follows in this preferred embodiment:
0=1427.000-1428.000 MHz
1=1428.000-1429.000 MHz
2=1429.000-1430.000 MHz
3=1430.000-1431.000 MHz
4=1431.000-1432.000 MHz

The system can be configured for implementation in varying global regions having different communication standards, for example the U.S. and Europe. The U.S. channels are spaced 100 kHz apart, with the first channel centered 50 kHz above the band edge. The European channels are spaced 60 kHz apart. Preferred frequencies for both Europe and the U.S. are listed in TABLE 1 below.

TABLE 1

| Channel | Frequency In Europe | Frequency In U.S. |
|---|---|---|
| 1 | 868.030 | 14xx.050 |
| 2 | 868.090 | 14xx.150 |
| 3 | 868.150 | 14xx.250 |
| 4 | 868.210 | 14xx.350 |
| 5 | 868.270 | 14xx.450 |
| 6 | 868.330 | 14xx.550 |
| 7 | 868.390 | 14xx.650 |
| 8 | 868.450 | 14xx.750 |
| 9 | 868.510 | 14xx.850 |
| Control | 868.570 | 14xx.950 |

Channel 0 is the wake-up or control channel and is the default setting from production in one example embodiment. Transmit deviations and data rates can vary between the U.S. and Europe due to the 100 kHz versus 60 kHz channel spacing. A central radio device in a cell will typically transmit more power than endpoint devices and is positioned higher in the air. Co-channel interference can occur if neighboring central radio devices can “see” each other in the radio frequency (RF) communication scheme. Therefore, in one example embodiment, the endpoint devices are designed to reduce co-channel interference with neighboring central radio devices by transmitting at a lower power level and incorporating a lower antenna height.

In this example embodiment, the individual cells within the system cell layout 10 are configured as hexagons for determination of area and meter density. Determination of RF coverage and hopping analysis will use circles. The area of a hexagon is defined as follows:
Ah=12*(r*cos 30*r*sin 30)/2
Ah=3*cos 30*r\hat{ }2, where r is the radius of the cell
Ah=2.598*r\hat{ }2

Assume for purposes of this analysis and explanation of a preferred system embodiment, that there is one residential meter per 33,508 square feet. This number may vary in a typical installation but serves as an exemplary starting point in the present analysis. TABLE 2 shows that at a range of 1000 feet from the mobile unit in such an area, there might be as many as 78 meters desired to be read.

TABLE 2

| r in feet | Ah in | Ah in | Number of |
|---|---|---|---|
| 100 | 25,980 | .0009 | 1 |
| 200 | 103,920 | .0037 | 3 |
| 400 | 415,680 | .0149 | 12 |
| 500 | 649,500 | .0233 | 19 |
| 800 | 1,662,720 | .0596 | 50 |
| 1000 | 2,598,000 | .0932 | 78 |
| 1200 | 3,741,120 | .1342 | 112 |
| 1500 | 5,845,500 | .2097 | 174 |
| 1800 | 8,417,520 | .3019 | 251 |
| 2000 | 10,392,000 | .3728 | 310 |
| 2500 | 16,237,500 | .5824 | 485 |
| 3000 | 23,382,000 | .8387 | 698 |

To determine cell coverage and propagation, several characteristics associated with the RF are used for these exemplary calculations:

| | |
|---|---|
| Sensitivity for central device | −110 dBm for 0.01 FER |
| Sensitivity for endpoint device | −105 dBm for 0.01 FER |
| Link Margin | 20 dB above sensitivity |
| Transmit Power (central) | +30 dBm or +14 dBm |
| Transmit Power (endpoint) | +14 dBm |
| Antenna Gain (central) | 3 dBi |
| Antenna Gain (endpoint) | 0 dBi |

Different path loss equations can be used for the loss between the different types of environments in which the system of the present invention may be utilized. The various equations each have a different breakpoint at which the loss changes from a free space loss to a higher exponent loss. The following calculation and TABLE 3 show the amount of loss for a given distance at 1430 MHz rounded to the nearest 0.1 dB:
PL=(10*loss exp)*log(distance)+25−((10*loss exp)−20 )*log(breakpoint)

TABLE 3

| | Free Space | Urban | Obstructed | Obstructed |
|---|---|---|---|---|
| Breakpoint In feet | 1 | 300 | 100 | 30 |
| Loss Exp. | 2 | 2.7 | 4 | 5.3 |
| Distance in feet | PL | PL | PL | PL |
| 50 | 59.2 | 59.2 | 59.2 | 66.5 |
| 100 | 65.2 | 65.2 | 65.2 | 82.5 |
| 200 | 71.3 | 71.3 | 77.3 | 98.4 |
| 350 | 76.1 | 76.6 | 87.0 | 111.3 |
| 500 | 79.2 | 80.8 | 93.2 | 119.5 |
| 800 | 83.3 | 86.3 | 101.4 | 130.4 |
| 1000 | 85.2 | 88.9 | 105.2 | 135.5 |
| 1500 | 88.8 | 93.6 | 112.3 | 144.8 |
| 2000 | 91.3 | 97.0 | 117.3 | 151.4 |
| 2500 | 93.2 | 99.6 | 121.1 | 156.6 |
| 3000 | 94.8 | 101.8 | 124.3 | 160.8 |

The above path loss equation and TABLE 3 provide a basis upon which to determine whether the radio devices in a particular cell can communicate with each other, whether the communication is between a central device and an endpoint device, or communication is between an endpoint device and another endpoint device. Additional factors can influence the equation above, however, and the path loss could vary considerably from what is calculated in this exemplary analysis.

Some observations can be made from the path loss in TABLE 3 and link margin calculations that provide an indication as to how large a cell can be to enable full communication between the devices within located within the cell. Refer, for example, to TABLE 4:

TABLE 4

| | Free Space | Urban Area | Obstructed | Obstructed |
|---|---|---|---|---|
| Breakpoint In feet | 1 | 300 | 100 | 30 |
| Loss Exp. | 2 | 2.7 | 4 | 5.3 |
| Distance for 118 dB | 43,500 feet | 11,970 feet | 2,086 feet | 468 feet |
| Distance for 102 dB | 6,900 feet | 3,060 feet | 831 feet | 233 feet |
| Distance for 107 dB | 12,260 feet | 4,685 feet | 1,108 feet | 290 feet |
| Distance for 99 dB | 4,880 feet | 2,368 feet | 699 feet | 205 feet |

Using a Loss Exp. of 4.0, a central RF device at +30 dBm and +14 dBm could communicate directly with over 96% of the endpoint devices in cells having a radius of 2100 and 1100 feet, respectively. Using a Loss Exp. of 4.0, over 96% of the endpoint devices in a cell could talk directly back to the central device at a range of almost 1100 feet. The percentage reduces to approximately 78% at a range of 2100 feet. Using a Loss Exp. of 4.0, the endpoint devices could talk peer-to-peer at a distance of 700 feet with an approximately 96% probability of successful communications. In a cell having a radius of 2000 feet, the central RF device could communicate directly with approximately 96% of the endpoint devices in the cell.

To get the last 4%, a peer-to-peer hopping scheme between endpoint devices and then the same path back to the central device could be implemented. Up to three hops out and three hops back may be needed in some system configurations. This method can require some additional time to hop, receive wake-up coordination/synchronization, compensation for real time clock (RTC) drift, and current drain on the battery-powered units. Any combination of hops could be made out and back to meet the required link margin. “Hole fillers,” or repeaters, could be implemented in the system and could be made at a low cost and mounted on houses instead of poles. If desired, an endpoint device could be used as a repeater if it had a suitable power supply. The advantages provided by this embodiment can be further improved in other embodiments of the invention.

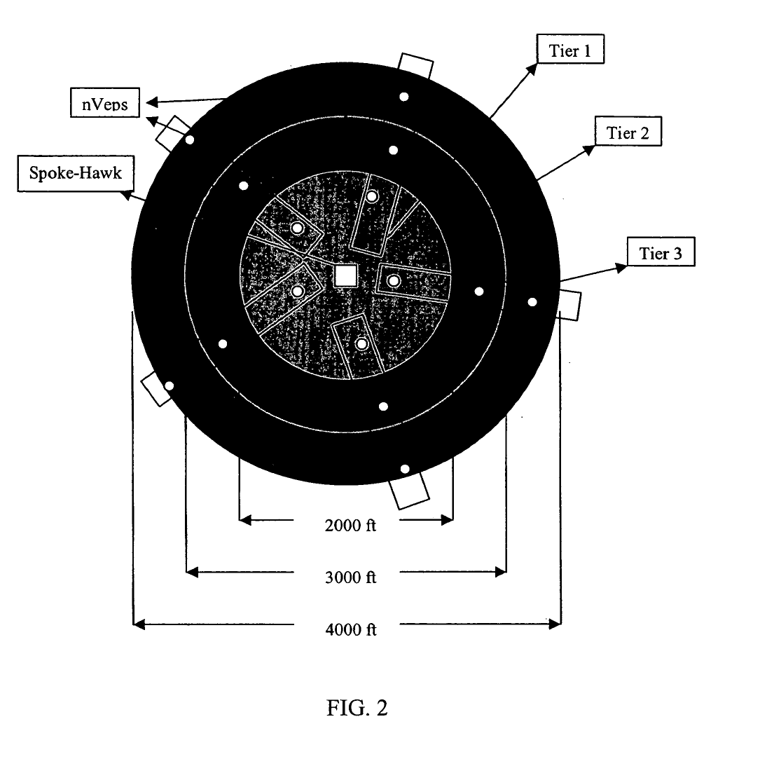

The cell layout 20 depicted in FIG. 2 is 4000 feet in diameter and can use up to three hops in a communication path. Additional hops can be used, which would shorten battery life. The cell layout 20 is based upon RF levels as opposed to a pure physical representation previously described with the hexagonal cell 10 in FIG. 1. A small number of endpoint devices 24 are shown for clarity. Note that coverage goes out from the central device 22 to the endpoint devices 24 in a “spoke-like” manner.

The central device 22 talks out on the cell channel to one of the spokes 26 in an assigned time slot. In a preferred embodiment, each of the devices 24 in the spoke 26 can hear the central device 22 with the required 20 dB link margin. One, two, or three endpoint devices 24 can be in a single spoke 26. If any of the endpoint devices 24 hear the central device 22, the information is “hopped” to them. The Tier 3 (28) endpoint device 24 then forms its data packet and sends the information back to the Tier 2 (30) endpoint device 24. The Tier 2 endpoint device 24 adds its data packet to the information received from the Tier 3 (28) endpoint device 24 and sends it to the Tier 1 (32) endpoint device 24. The Tier 1 endpoint device 24 then adds its data packet to the information received from the Tier 2 (30) endpoint device 24 and sends the total packet up to the central device 22. Data rate peer-to-peer and central device 22 to endpoint devices 24 will generally be slower, for example 4.8/9.6 kbaud, than from endpoint device 24 to central device 22, for example 4.8/9.6/19.2/38.4 kbaud, because of the lower processor power in the endpoint device 24 as compared to the central device 22.

After the central device 22 receives the data packet, it waits for the next assigned time slot and repeats the process. Endpoint device 24 density, range peer-to-peer, transmission time and current drain of battery powered devices will be factors in these operations.

To conserve resources, battery power system devices, for example the endpoint devices 24, will preferably be in some form of sleep mode until their assigned time slot comes up. The receiver/PLL/uC of the endpoint device 24 is preferably powered up and listening for the central device 22 when the central device 22 transmits. In an example embodiment, the message from central device 22 contains bit/frame synchronization, identification of endpoint device 24 in spoke 26, the hop order, the command to send the data, and a CRC. Synchronization of the RTCs can also be in the protocol structure in this embodiment.

In an example embodiment of the system of the invention, the initial synchronization is accomplished by having each endpoint device 24 go into a transmit bubble-up mode as shipped from the factory. The central device 22 will hear the endpoint device 24 with received signal strength indicator (RSSI) information and provide the device 24 with a time slot to listen in. A percentage of endpoint devices 24 could still not be found this way because the central device 22 cannot hear them. Because the geographical location, identified by latitude and longitude, of each installed device 24 will typically be known, an endpoint device 24 close to a “lost” device could be commanded by the nearby and previously identified endpoint device 24 to listen in prescribed time slots for these lost devices. As devices 24 are located and register with the central device 22, the devices 24 can be sent updates every five to fifteen minutes to keep their RTCs synchronized.

In a preferred embodiment, the routes or spokes 26 are optimized for efficient system communication. A “Who Can Hear Me” communication is issued to each device 24 in cell 20 and a path loss between each device 22, 24 is reported back to central device 22 and then to the Head-End, for example a utility control center, through a wireless area network. A path loss matrix can be formed to optimize spokes 26 using predetermined routing algorithms. Manual routing can be used in special cases.

In one example operation, central device 22 knows that the read slot for one of spokes 26, for example spoke 26A, is coming up. Central device 22 sends out a command that is 60 bytes long to endpoint device 24A at 9600 baud. This 50 ms burst contains dotting pattern, 3-byte frame sync, endpoint device identification, hop path, the command to read, and a 16CRC. If endpoint device 24A does not hear the central device 22 command, the endpoint device 24A goes back into sleep mode. If endpoint device 24A receives the command, the command is relayed to endpoint device 24B. Endpoint device 24B receives the command and next relays it to endpoint device 24C. Endpoint device 24C receives the command and forms the return data message. This message is preferably 120 bytes long and takes 100 ms to transmit. Endpoint device 24B then receives this message from endpoint device 24C and adds its data to it. The message is now 240 bytes long and takes 200 ms for endpoint device 24B to send it to endpoint device 24A in one preferred embodiment. Endpoint device 24A receives this message and adds its data. These data messages and commands are preferably sent at 9600 baud. Because central device 22 has much more computing power, it is capable of receiving data at 19,200 baud. Endpoint device 24A therefore sends this 360-byte data message to central device 22 at 19,200 baud, which takes 150 ms. This timing line is shown in FIG. 4.

A full sequence takes 0.6 seconds and collects data from three endpoint devices 24A-C in this embodiment. Many more combinations of data rate, data length, multiple packets, and hops could be calculated and can be implemented in other various embodiments of the system of the invention. If, for example, the cell 20 had a 2000-foot radius, the cell 20 could contain approximately 310 central devices 24 according to TABLE 2. The entire cell 20 of 310 devices could be read in 62.4 seconds, or a little over one minute, by following the sequence described above 104 times. Provisions can be made for latency, RTC error, retries, second path tries, time between spoke reads, larger packets of data, multiple packets of data, and spokes that have more or fewer then three devices in them. This could double the time required to read cell 20, meaning that cell 20 could be read every fifteen minutes.

There will be occasions when an endpoint device 24 will lose synchronization with the central device 22. In one embodiment, endpoint device 24 can go to the control channel if device 24 has not received communication from central device 22 or other endpoint devices 24 for several time slots. Endpoint device 24 could also go into a transmit bubble-up mode and the central device 22 could listen when not doing reads. If central device 22 hears one of the lost endpoint devices 24, central device 22 could respond with a new RTC setting and the time slot when endpoint device 24 should wake up for the next read. Some form of this method could also be used to obtain initial synchronization.

In another preferred embodiment, lost endpoint device 24 goes to the control channel and receives for 10 ms at a rate of every 15 seconds. If device 24 hears central device 22 trying to find it, device 24 will respond. Central device 22 will then send the lost endpoint device 24 a new RTC setting and the time slot when device 24 should wake-up for the next read.

Data packet sizes will influence system timing because larger packets will take more time to transmit. The nominal size of a data packet in one embodiment of the system is 120 bytes. This data packet will have two bytes of bit synchronization, two bytes of frame synchronization, four bytes of central device 22 identification, twelve bytes of endpoint device 24 identification, two bytes of command protocol, 96 bytes of data, and two bytes of CRC. The 96 bytes of data will allow for 48 IDR times if two bytes/time are allowed in this embodiment. This is enough for four hours of reads with a five-minute interval. This packet could alternatively be made smaller or larger as needed in other embodiments of the system of the present invention.

Data packet speeds will generally depend upon the receive detection scheme, microcontroller horsepower, and current. In one embodiment, 9600-baud, Manchester encoded data may be decoded in a relatively inexpensive microcontroller. If the data rate can be increased without sacrificing current, the transmitters and receivers in each spoke 26 will require less battery power. This could increase cell 20 read speeds and save battery life. Hardware can also be used to detect and extract the NRZ data from the Manchester encoded data. These configurations could reduce system costs, in particular reduce battery drain.

The bandwidth of the modulated signal is a function of many things, including the data rate, encoding technique, deviation, data wave shape generation, and base-band filtering. The endpoint device 24 to central device 22 will use some form of FSK (MSK, GMSK, C4FM) modulation with 19.2 kbps Manchester encoded data. Deviation is expected to be ±20 kHz in this embodiment. Using Carson's rule, the approximate bandwidth is as follows:
BW=2*Peak Deviation+2*Base-band bandwidth
BW=2*20 kHz+2*19.2 kHz
BW=78.4 kHz
The central device 22 to endpoint device 24 or endpoint device 24 to endpoint device 24 in turn will use some form of frequency shift keying modulation with 9.6 kbps Manchester encoded data. Deviation is expected to be ±20 kHz. Using Carson's rule, the approximate bandwidth is as follows:
BW=2*Peak Deviation+2*Base-band bandwidth
BW=2*20 kHz+2*9.6 kHz
BW=59.2 kHz
These bandwidths will comply with the preferred U.S. 100 kHz channels. Deviations or data rates could be reduced for the European system with its 60 kHz channels.

Each endpoint device 24 in a spoke 26 knows when to come up and put itself in receive mode to listen for the central device 22 or endpoint device 24 upstream. If a device's RTC is out of synchronization, even by only a small amount, the device 24 will miss the read command and the associated RTC update.

The RTC is preferably running all the time, even during the endpoint device 24 sleep time. This clock and a counter in the microcontroller will tell the receiver when to turn on. Because this clock is preferably at a low frequency to keep the sleep mode current low, a 32 kHz crystal can be used. In one embodiment, the 32 kHz crystal is a “BT” cut with parabolic TC curve having a reference setting at +25 C. Over the −40 C to +80 C temperature range, this crystal could move up to −150 ppm. In a 15-minute period this translates to −135 ms. This amount of time is more than twice as large as the assumed 50 ms period of the initial wake up slot. One way to account for this error is to put the endpoint device 24 in the receive mode for a longer period of time.

Another correction scheme would set up a timing correction loop between the 32 kHz crystal in the endpoint device 24 and the timing of the slotted wake-up from the central device 22. Every 15-minute read would reset the RTC counter number in the endpoint device 24 assuming the central device 22 has a much more accurate crystal reference, for example ±0.5 ppm. During the next 15-minute window, the endpoint device 24 will be compensated to the previous 15-minute read window. It is assumed that the endpoint device 24 will change temperature only a small amount during 15 minutes to tighten up the error to ±15 ppm. This would make the timing error in 15 minutes only 13.5 ms. The receive time slot of the endpoint device 24 would then be 77 ms.

Endpoint devices are generally battery powered. Extending battery life in these devices reduces the overall cost of an AMR system because it also reduces the need for personnel to physically visit each device to change out batteries. In the three-hop read described above, reads are obtained every fifteen minutes and the endpoint devices 24 are either in sleep mode, receive mode, or transmit mode. Battery life of endpoint devices 24 used multiple times in a spoke 26 is reduced because these intermediate devices are transmitting and receiving more frequently. The overall system efficiency and cost savings, however, are still improved when compared to systems that require on-site manual reading by personnel.

The present invention may be embodied in other specific forms without departing from the essential attributes thereof; therefore, the illustrated embodiments should be considered in all respects as illustrative and not restrictive. The claims provided herein are to ensure adequacy of the present application for establishing foreign priority and for no other purpose.

1. A fixed network utility data collection system, comprising:
a plurality of endpoints, wherein each of said plurality of endpoints is operably connected to a utility meter, wherein said plurality of endpoints are arranged in a multi-level tier arrangement having at least an outer tier, an intermediate tier, and an inner tier, wherein said plurality of endpoints are further arranged in a multi-spoke configuration wherein each spoke includes one endpoint from said outer tier, one endpoint from said intermediate tier, and one endpoint from said inner tier; and
a central device, wherein said central device emits an RF transmission, and wherein any one of said endpoints within one of said spokes may hear said RF transmission, and, upon any one of said endpoints hearing said RF transmission, the hearing endpoint hops said RF transmission to the other endpoints within its spoke; and
wherein upon hearing said RF transmission, the endpoints respond to said central device, wherein said response is initiated by the outer tier endpoint of the spoke and sent to said intermediate tier endpoint of the spoke, wherein said intermediate tier endpoint adds its response to the response from the outer tier endpoint of the spoke and sends the added response to the inner tier endpoint of the spoke, wherein the inner tier endpoint of the spoke adds its response to the added response to produce a final response which is sent to the central device.

2. The system of claim 1, wherein said fixed network utility data collection system operates in the 1.427 GHz to 1.432 GHz frequency band.

3. The system of claim 1, wherein said fixed network utility data collection system operates across five communication channels.

4. The system of claim 3, wherein said five communication channels include a control channel.

5. The system of claim 1, wherein each spoke further includes a repeater.

6. The system of claim 1, wherein communication between endpoints in a spoke occurs at a slower rate than communication between the inner tier endpoint of the spoke and said central device.

7. The system of claim 1, wherein the endpoints within the spoke remain in a sleep mode until a designated communication time occurs.

8. A method for collecting utility data within a fixed network that includes a plurality of endpoints, each of which is operably connected to a utility meter, and a central device, the method comprising the steps of:
placing said plurality of endpoints in a multi-tier arrangement, wherein said tiers include an outer tier, an intermediate tier, and an inner tier;
arranging said plurality of endpoints in a spoke configuration within said multi-tier arrangement, wherein each spoke includes one endpoint from said outer tier, one endpoint from said intermediate tier, and one endpoint from said inner tier;
emitting an RF transmission from said central device;
listening for said RF transmission with said plurality of endpoints;
wherein upon an endpoint hearing said RF transmission, transmitting the heard RF transmission to the other endpoints within the spoke of the hearing endpoint;
responding to said RF transmission by said outer tier endpoint of a spoke transmitting a response to the intermediate tier endpoint of the spoke, subsequently said intermediate tier endpoint adding its response to that of the outer tier endpoint and transmitting the added response to the inner tier endpoint of the spoke, subsequently said inner tier endpoint of the spoke added its response to the added response to produce a final response, and transmitting said final response from said inner tier endpoint of the spoke to said central device.

9. The method of claim 8, wherein said method occurs in the 1.427 to 1.432 GHz frequency band.

10. The method of claim 8, wherein said method utilizes five communication channels.

11. The method of claim 10, wherein said five communication channels includes a control channel.

12. The method of claim 8, wherein said step of arranging said plurality of endpoints in a spoke configuration further comprises incorporating a repeater into each spoke.

13. The method of claim 8, wherein transmissions between endpoints within a spoke occur at a slower rate of communication than transmissions between the central device and the inner tier endpoint of the spoke.

14. The method of claim 8, wherein the endpoints within the spoke remain in a sleep mode until a designated communication time occurs.

15. A fixed network utility data collection system, comprising:
a plurality of endpoints, wherein each of said endpoints is operably connected to a utility meter; and
a central device, wherein said central device in communication with a first one of said plurality of endpoints;
wherein upon said first one of said plurality of endpoints receiving a transmission from said central device, said first one of said plurality of endpoints hops said transmission to a second of said plurality of endpoints, and wherein upon said second one of said plurality of endpoints receiving said transmission, said second one of said plurality of endpoints hops said transmission to a third of said plurality of endpoints; and
wherein upon said third of said plurality of endpoints receiving said transmission, said third of said plurality of endpoints responds to said transmission with a message to said second of said plurality of endpoints, wherein said second of said plurality of endpoints receives said message, adds its own response to said transmission to the message and sends the added message to said first of said plurality of endpoints, and wherein said first of said plurality of endpoints receives the added message, adds its own response to the transmission to the added message to produce a final message, and transmits said final message to said central device.

16. The system of claim 15, wherein said fixed network utility data collection system operates in the 1.427 GHz to 1.432 GHz frequency band.

17. The system of claim 15, wherein said fixed network utility data collection system operates across five communication channels.

18. The system of claim 17, wherein said five communication channels include a control channel.

19. The system of claim 15, wherein said system further includes a plurality of repeaters.

20. The system of claim 15, wherein communication between first, second and third endpoints occurs at a slower rate than communication between the first endpoint and said central device.

21. The system of claim 15, wherein the endpoints remain in a sleep mode until a designated communication time occurs.
